(19) United States
(12) Patent Application Publication
(10) Pub. No.: US 2020/0262507 A1
(43) Pub. Date: Aug. 20, 2020

(54) GRIP ASSEMBLY

(71) Applicant: HAYES BICYCLE GROUP INC., Mequon, WI (US)

(72) Inventors: Kyle J. BEUTIN, Wauwatosa, WI (US); Jon E. SWANSON, Cedarburg, WI (US)

(21) Appl. No.: 16/773,975

(22) Filed: Jan. 27, 2020

Related U.S. Application Data
(60) Provisional application No. 62/799,703, filed on Jan. 31, 2019.

(51) Int. Cl. B62K 21/26

(52) U.S. Cl. CPC B62K 21/26

(57) ABSTRACT

A grip assembly for a handlebar of a bicycle is disclosed. The grip assembly may be configured to be mounted on the handlebar of a bicycle using a retaining mechanism of an accessory mounted on the handlebar. The grip assembly may comprise a base configured to be installed onto the handlebar providing a first end and a second end; the base may comprise a sleeve at the second end; the sleeve of second end of the base may be configured to be retained to the handlebar by the retaining mechanism of the accessory. The grip assembly may comprise a base configured to be installed onto the handlebar providing a first end and a second end and a retaining mechanism configured to retain the first end of the base onto the handlebar. The retaining mechanism for the first end of the base may comprise a clamp or a collar configured to be secured onto the handlebar at the cutout at the first end of the base. The sleeve may be configured to be compressed onto the handlebar by the retaining mechanism for the accessory. The accessory may comprise one of a brake control or a gear shift control. The grip assembly may be secured by a method comprising the steps of sliding the base onto the handlebar and securing the second end to the handlebar with the retaining arrangement of the accessory. The method may comprise the step of securing the first end to the handlebar with the retaining arrangement. The step of securing the first end may be performed before the step of securing the second end. The step of securing the second end of the handlebar may comprise at least partially compressing the sleeve onto the handlebar.

### CROSS-REFERENCE TO RELATED APPLICATIONS

The present application claims priority to and incorporates by reference in full the following patent application(s): U.S. Provisional Patent Application No. 62/799,703 titled “GRIP ASSEMBLY” filed Jan. 31, 2019.

### FIELD

The present invention relates to a grip assembly for a bicycle.

### BACKGROUND

It is known to provide a grip assembly to be installed on the handlebar of a bicycle; it is known to provide for an arrangement to clamp the grip assembly onto the handlebar at each end. It is also known to provide for an accessory (or multiple accessories) to be installed onto the handlebar of a bicycle, such as a brake control and/or a shift control; it is also known to provide for an arrangement to clamp the accessory onto the handlebar. It is further known to provide for a bicycle for youthful/children riders that comprises a handlebar of a smaller diameter.

It would be advantageous to provide an improved grip assembly configured to provide one or more advantageous features. It would be advantageous to provide a grip assembly configured to be retained on the handlebar using (at least partially) the clamp arrangement of an accessory (such as a brake control or gear/shift control). It would also be advantageous to provide for a grip assembly configured to fit better the smaller hands of youthful/children riders and/or onto a handlebar of smaller diameter.

### SUMMARY

The present invention relates to a grip assembly configured to be mounted on a handlebar of a bicycle using a retaining mechanism of an accessory to be mounted on the handlebar comprising a base configured to be installed onto the handlebar providing a first end and a second end; the base may comprise a sleeve at the second end; the sleeve of second end of the base may be configured to be retained to the handlebar by the retaining mechanism of the accessory. The retaining mechanism may be configured to retain the first end of the base onto the handlebar. The retaining mechanism for the first end of the base may comprise a clamp. The retaining mechanism for the first end of the base may comprise a collar; the collar may be secured by a fastener. The retaining mechanism for the accessory may comprise a clamp; the clamp may be secured by at least one fastener. The sleeve may be configured to be compressed onto the handlebar by the retaining mechanism for the accessory. The grip assembly may comprise a grip for the base; the grip may comprise an overmold. The accessory may comprise one of a brake control or a gear shift control.

The present invention relates to a method of attachment of a grip assembly comprising a base with a first end and a second end comprising a sleeve onto a handlebar of a bicycle also configured for attachment of at least one accessory with a retaining arrangement; the method may comprise the steps of: (a) sliding the base onto the handlebar and (b) securing the second end to the handlebar with the retaining arrangement of the accessory. The base may be secured to the handlebar at the second end with the sleeve by the retaining arrangement of the accessory. The first end of the grip assembly may comprise a retaining arrangement. The method may comprise the step of securing the first end to the handlebar with the retaining arrangement so that the base may be secured to the handlebar at the first end by the retaining arrangement of the base; the retaining arrangement for the first end may comprise a collar. The retaining arrangement of the accessory may comprise a clamp. Each retaining arrangement may comprise a retaining mechanism. The retaining mechanism may comprise a clamp.

The present invention relates to a grip assembly configured to be mounted on a handlebar of a bicycle using a retaining mechanism of an accessory to be mounted on the handlebar comprising a base configured to be installed onto the handlebar providing a first end and a second end and a retaining mechanism configured to retain the first end of the base onto the handlebar. The base may comprise a cutout at the first end; the base may comprise a sleeve at the second end; the sleeve of second end of the base may be configured to be retained to the handlebar by the retaining mechanism of the accessory. The retaining mechanism for the first end of the base may comprise a clamp. The retaining mechanism for the first end of the base may comprise a collar; the collar may be secured by a fastener. The retaining mechanism for the accessory may comprise a clamp; the clamp may be secured by at least one fastener. The sleeve may be configured to be compressed onto the handlebar by the retaining mechanism for the accessory. The grip assembly may comprise a grip for the base; the grip may comprise an overmold. The accessory may comprise one of a brake control or a gear shift control.

The present invention relates to a grip assembly configured to be mounted on a handlebar of a bicycle using a retaining mechanism of an accessory to be mounted on the handlebar comprising a base configured to be installed onto the handlebar providing a first end and a second end; the base may comprise a sleeve at the second end; the sleeve of second end of the base may be configured to be retained to the handlebar by the retaining mechanism of the accessory. The retaining mechanism may be configured to retain the first end of the base onto the handlebar. The sleeve may comprise a slot arrangement. The retaining mechanism for the first end of the base may comprise a clamp. The retaining mechanism for the first end of the base may comprise a collar. The collar may be secured by a fastener. The base may comprise a cutout at the first end; the collar may be configured to be secured onto the handlebar at the cutout at the first end of the base. The retaining mechanism for the accessory may comprise a clamp. The clamp may be secured by at least one fastener. The sleeve may be configured to be compressed onto the handlebar by the retaining mechanism for the accessory. The slot arrangement may comprise a single slot. The slot arrangement may comprise multiple slots. The sleeve may comprise features configured to facilitate engagement with the handlebar for secure attachment. The features may comprise grooves. The grip assembly may comprise a grip for the base. The grip may comprise an overmold. The accessory may comprise one of a brake control or a gear shift control. The base may comprise an end cap. The grip assembly may comprise an end cap for the second end. The end cap may comprise a slot.

The grip assembly may be secured by a method comprising the steps of sliding the base onto the handlebar and securing the second end to the handlebar with the retaining arrangement of the accessory. The grip assembly may be secured by a method comprising the steps of sliding the base onto the handlebar and securing the first end to the handlebar with the retaining arrangement and securing the second end to the handlebar with the retaining arrangement of the accessory.

The present invention relates to a method of attachment of a grip assembly comprising a base with a first end and a second end comprising a sleeve onto a handlebar of a bicycle also configured for attachment of at least one accessory with a retaining arrangement may comprise the steps of (a) sliding the base onto the handlebar and (b) securing the second end to the handlebar with the retaining arrangement of the accessory; the base may be secured to the handlebar at the second end with the sleeve by the retaining arrangement of the accessory. The method of attachment for a grip assembly with the first end comprising a retaining arrangement may comprise the step of securing the first end to the handlebar with the retaining arrangement so that the base may be secured to the handlebar at the first end by the retaining arrangement of the base. The retaining arrangement for the first end may comprise a collar. The retaining arrangement of the accessory may comprise a clamp. The step of securing the first end may be performed before the step of securing the second end. The step of securing the second end may be performed before the step of securing the first end. The method may comprise the step of fitting the accessory onto the handlebar. The step of fitting the accessory onto the handlebar may comprise sliding the accessory onto the handlebar. The method may comprise the step of providing a grip for the grip assembly. The step of securing the second end of the handlebar may comprise at least partially compressing the sleeve onto the handlebar. Each retaining arrangement may comprise a retaining mechanism. The retaining mechanism may comprise a clamp

The present invention relates to a grip assembly configured to be mounted on a handlebar of a bicycle using a retaining mechanism to be mounted on the handlebar comprising a base configured to be installed onto the handlebar providing a first end and a second end; the base may comprise a sleeve at the second end; the base may comprise an end cap; the sleeve of second end of the base may be configured to be retained to the handlebar by the retaining mechanism. The retaining mechanism may comprise a clamp at the second end. The retaining mechanism may comprise a clamp at the first end. The retaining mechanism may comprise an accessory. The clamp at the second end may comprise an accessory.

The present invention relates to a grip assembly configured to be mounted on a handlebar of a bicycle using a retaining mechanism of an accessory to be mounted on the handlebar comprising (a) a base configured to be installed onto the handlebar providing a first end and a second end; and (b) a retaining mechanism configured to retain the first end of the base onto the handlebar. The base may comprise a cutout at the first end. The base may comprise a sleeve at the second end. The sleeve of second end of the base may be configured to be retained to the handlebar by the retaining mechanism of the accessory. The sleeve may comprise a slot arrangement at the second end. The retaining mechanism for the first end of the base may comprise a clamp. The retaining mechanism for the first end of the base may comprise a collar. The collar may be secured by a fastener. The collar may be configured to be secured onto the handlebar at the cutout at the first end of the base. The retaining mechanism for the accessory may comprise a clamp. The clamp may be secured by at least one fastener. The sleeve may be configured to be compressed onto the handlebar by the retaining mechanism for the accessory. The sleeve may comprise features configured to facilitate engagement with the handlebar for secure attachment. The features may comprise grooves. The grip mechanism may comprise a grip for the base. The grip may comprise an overmold. The accessory may comprise one of a brake control or a gear shift control. The slot arrangement of the sleeve may comprise a single slot. The slot arrangement of the sleeve may comprise multiple slots. The grip assembly may comprise an end cap for the second end. The grip assembly may be secured by a method comprising the steps of sliding the base onto the handlebar and securing the first end to the handlebar with the retaining arrangement and securing the second end to the handlebar with the retaining arrangement of the accessory.

The present invention relates to a method of attachment of a grip assembly comprising a base with a first end with a retaining arrangement and a second end comprising a sleeve onto a handlebar of a bicycle also configured for attachment of at least one accessory with a retaining arrangement. The method may comprise the steps of (a) sliding the base onto the handlebar; (b) securing the first end to the handlebar with the retaining arrangement; (c) securing the second end to the handlebar with the retaining arrangement of the accessory. The base may be secured to the handlebar at the first end by the retaining arrangement of the base and at the second end with the sleeve by the retaining arrangement of the accessory. The retaining arrangement may comprise a collar. The retaining arrangement of the accessory may comprise a clamp. The step of securing the first end may be performed before the step of securing the second end. The step of securing the second end may be performed before the step of securing the first end. The method may comprise the step of fitting the accessory onto the handlebar. The step of fitting the accessory onto the handlebar may comprise sliding the accessory onto the handlebar. The method may comprise the step of providing a grip for the grip assembly. The step of securing the second end of the handlebar may comprise at least partially compressing the sleeve onto the handlebar. Each retaining arrangement may comprise a retaining mechanism. The retaining mechanism may comprise a clamp.

### FIGURES

FIG. 1 is schematic perspective view of a bicycle according to an exemplary embodiment.

FIG. 2 is a schematic view of a brake control and a grip for a handlebar.

FIGS. 3 and 4 are schematic perspective views of an accessory and a grip on a handlebar for a bicycle according to an exemplary embodiment.

FIG. 5A is a schematic perspective view of an accessory and a grip on a handlebar for a bicycle according to an exemplary embodiment.

FIG. 5B is a schematic exploded perspective view of an accessory and a grip on a handlebar for a bicycle according to an exemplary embodiment.

FIG. 5C is a schematic exploded perspective view of a grip for a handlebar for a bicycle according to an exemplary embodiment.

FIG. 6A is a schematic view of an accessory and a grip on a handlebar according to an exemplary embodiment.

FIG. 6B is a schematic cross-section view of a grip on a handlebar according to an exemplary embodiment.

FIGS. 7A and 7B are schematic perspective views of a grip for a handlebar according to an exemplary embodiment.

FIG. 7C is schematic view of a grip for a handlebar according to an exemplary embodiment.

FIG. 7D is schematic cross-section view of a grip for a handlebar according to an exemplary embodiment.

FIGS. 7E and 7F are schematic cross-section end views of a grip for a handlebar according to an exemplary embodiment.

FIGS. 8A and 8B are schematic perspective views of a grip for a handlebar according to an exemplary embodiment.

FIG. 8C is schematic view of a grip for a handlebar according to an exemplary embodiment.

FIG. 8D is schematic cross-section view of a grip for a handlebar according to an exemplary embodiment.

FIGS. 8E and 8F are schematic cross-section end views of a grip for a handlebar according to an exemplary embodiment.

### DESCRIPTION

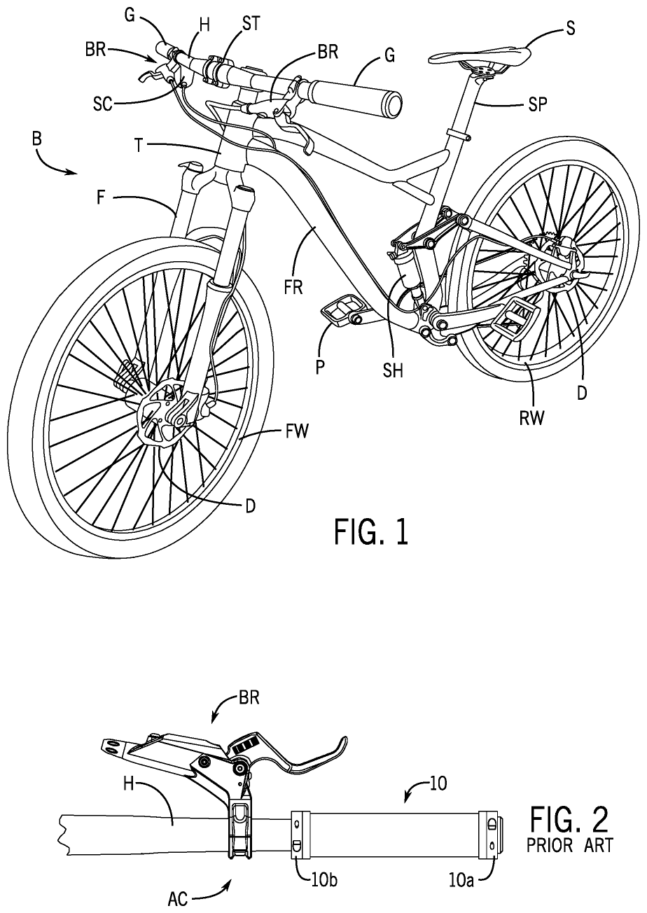

Referring to FIG. 1, a bicycle BR (such as a mountain bike) is shown schematically according to an exemplary embodiment providing an arrangement of parts/components including a frame FR with a steering tube T and a seat post SP (with seat S) and a set of wheels comprising front wheel FW with a front fork assembly F and rear wheel RW coupled to the frame FR and through a rear shock absorber SH (of a suspension system) and a set of pedals P; the bicycle provides handlebar H (coupled to front wheel FW through stem ST and front fork assembly F and through steering tube T) with a grip G and controls for a brake system BR coupled to a brake disc D (e.g. rotor at/on each of front wheel FW and rear wheel RW) and a gear/shift control SC (coupled to a selectable gear system for rear wheel RW).

Referring to FIG. 2, a conventional arrangement for a grip assembly 10 installed onto a handlebar H is shown; the grip assembly 10 comprises a set of clamps 10a and 10b (one at each end of the grip assembly) to retain the grip assembly onto the handlebar H; the grip assembly 10 is installed onto the handlebar H adjacent to an accessory shown as brake control BR.

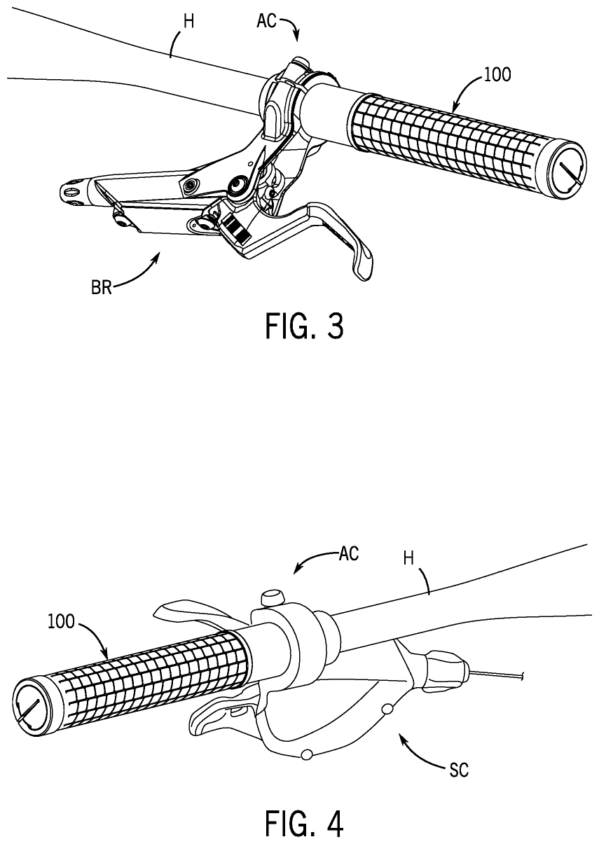

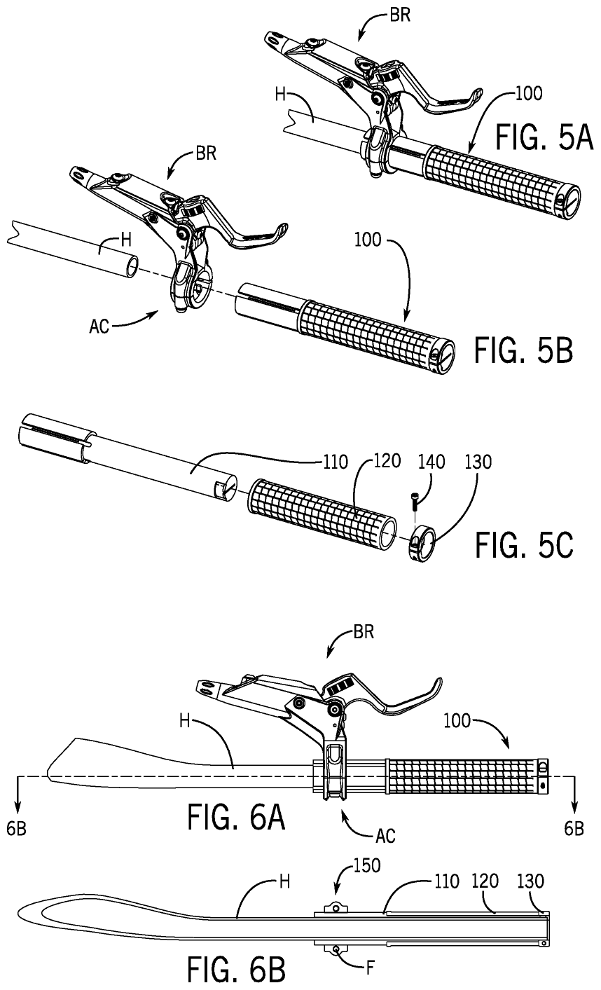

Referring to FIGS. 3 and 4, an improved a grip assembly 100 is shown schematically according to an exemplary embodiment; as indicated schematically, the grip assembly 100 is configured to be attached to the handlebar H by a clamp associated with an accessory shown as brake control BR (FIG. 3) or gear shift control SC (FIG. 4). As indicated schematically in FIGS. 5A to 5C and 6A to 6B, the grip assembly 100 comprises a base 110 that fits onto the handlebar H and a grip/overmold portion 120 that fits onto the base 110; the grip assembly 100 is retained onto the handlebar H at one end by a retaining mechanism with a clamp shown as collar/ring 130 secured by a fastener shown as screw 140 and at the other end by retaining mechanism shown as a clamp AC (secured by a fastener arrangement with screws, bolts, etc.) configured to retain accessory shown as brake control BR.

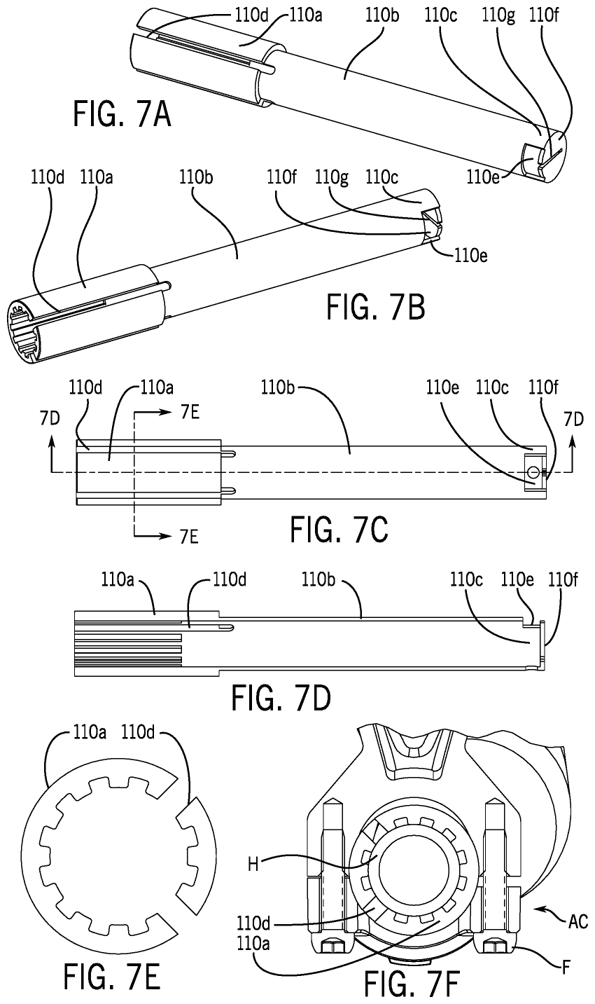

Referring to FIGS. 7A to 7B and 7C to 7D, the base 110 of the grip assembly comprises a sleeve section 110a (configured for a retaining mechanism) and a body section 110b (for grip/overmold 120) and an end section 110c (configured for a retaining mechanism); the sleeve section 110a comprises a slot arrangement shown schematically as comprising a set of slots 110d. As shown schematically in FIGS. 7A and 7C, the end section 110c comprises a cutout 110e and an end cap 110f (shown with a slot 210g). As shown schematically in FIGS. 7E and 7F, the sleeve section 110a with slot arrangement 110d and features (shown as grooves) is configured to fit onto the handlebar H; the sleeve section 110a is configured to be retained onto handlebar H by the retaining mechanism AC of the accessory by clamping force/compression. As shown schematically in FIG. 7F, the retaining mechanism shown as clamp AC with fastener arrangement shown as with screws F is tightened to compress sleeve section 110a with slot arrangement 110d (and grooves) to retain the grip assembly and accessory onto the handlebar H.

As indicated schematically in FIGS. 5A-5C and 7A-7D, at end section 110c is retained onto handlebar H by the retaining mechanism shown as collar 130 with fastener 140 by clamping force/compression; the collar 140 with fastener shown as screw 140 is tightened to compress end section 110c with cutout 110e (and endcap 110f with cutout 110g) to retain the base of grip assembly onto the handlebar H.

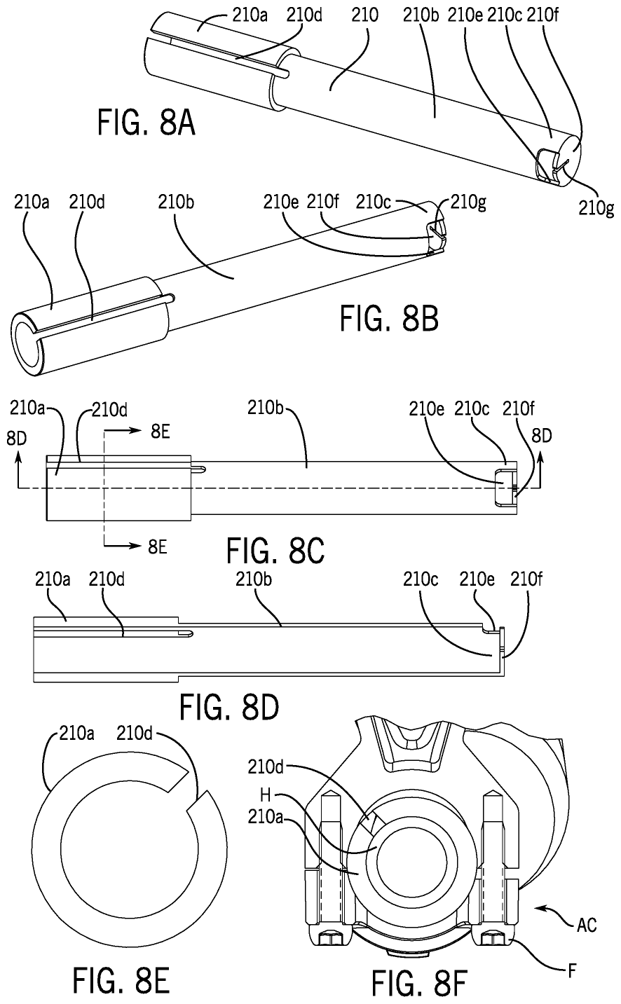

Referring to FIGS. 8A to 8B and 8C to 8D, the base 210 of the grip assembly comprises a sleeve section 210a and a body section 210b and an end section 210c; the sleeve section 210a comprises a slot arrangement shown schematically as comprising a set of slots 210d. As shown schematically, the end section 210c comprises a cutout 210e and an end cap 210f (shown with a slot 210g). As shown schematically in FIGS. 8E and 8F, the sleeve section 210a with slot 210d is configured to fit onto the handlebar H; the sleeve section 210a is configured to be retained onto handlebar H by the retaining mechanism AC of the accessory by clamping force/compression. As shown schematically in FIG. 8F, the retaining mechanism shown as clamp AC with fastener arrangement shown as with screws F is tightened to compress sleeve section 210a with slot 210d to retain the base of grip assembly and accessory onto the handlebar H.

As indicated schematically in FIGS. 5A-5C and 8A-8D, at end section 210c is retained onto handlebar H by the retaining mechanism shown as collar 130 with fastener 140 by clamping force/compression; the collar 130 with fastener shown as screw 140 is tightened to compress end section 210c with cutout 210e (and endcap 210f with cutout 210g) to retain the base of grip assembly onto the handlebar H.

As shown schematically according to an exemplary embodiment in the FIGURES, the handlebar for the bicycle is provided as a tube/tubular form (e.g. with a size/diameter); as indicated schematically, the bicycle may be provided with a handlebar of a smaller size/diameter to accommodate smaller hands (e.g. for youthful/children riders). As indicated schematically, the grip assembly may be provided in a diameter to fit the handlebar/bicycle (e.g. configured with a standard diameter to fit a standard handlebar/diameter or a smaller diameter to fit a smaller handlebar/diameter). See generally FIGS. 1 and 3-4.

As shown schematically/generally in FIGS. 1, 3 and 4, the grip assembly may be secured with any of a variety of retaining mechanisms (e.g. clamp, collar, ring, clip, etc.) provided by any of a variety of accessories; the grip assembly may be secured at one end of the handlebar with a retaining mechanism of one type of accessory (e.g. brake control, shift control, etc.). and the grip assembly may be secured at the other end of the handlebar with a retaining mechanism of another type (or same type) of accessory (e.g. brake control, shift control, etc.).

### EXEMPLARY EMBODIMENTS

According to an exemplary embodiment as shown schematically in FIGS. 3-4, 5A-5C and 6A-6B, a grip assembly may be configured to be mounted on a handlebar of a bicycle using a retaining mechanism of an accessory to be mounted on the handlebar comprising a base configured to be installed onto the handlebar providing a first end and a second end; the base may comprise a sleeve at the second end; the sleeve of second end of the base may be configured to be retained to the handlebar by the retaining mechanism of the accessory. See e.g. FIGS. 3, 4, 5A-5B, 6A-6B, 7A-7F and 8A-8F. The retaining mechanism may be configured to retain the first end of the base onto the handlebar; the retaining mechanism for the first end of the base may comprise a clamp; the retaining mechanism for the first end of the base may comprise a collar; the collar may be secured by a fastener. See e.g. FIGS. 5A-5C, 7A-7F and 8A-8F. The base may comprise a cutout at the first end; the collar may be configured to be secured onto the handlebar at the cutout at the first end of the base. See e.g. FIGS. 5A-5C, 6A-6B, 7A-7D and 8A-8D. The retaining mechanism for the accessory may comprise a clamp; the clamp may be secured by at least one fastener. See e.g. FIGS. 3, 4, 5A-5B, 6A-6B, 7F and 8F.

According to an exemplary embodiment as shown schematically in FIGS. 3-4, 5A-5C and 6A-6B, the sleeve may be configured to be compressed onto the handlebar by the retaining mechanism for the accessory. The sleeve may comprise a slot arrangement; the slot arrangement may comprise a single slot; the slot arrangement may comprise multiple slots; the sleeve may comprise features configured to facilitate engagement with the handlebar for secure attachment. The features may comprise grooves. See e.g. FIGS. 5A-5C, 7A-7F and 8A-8F. The grip assembly may comprise a grip for the base; the grip may comprise an overmold. See e.g. FIGS. 3, 4, 5A-5C and 6A-6B. The accessory may comprise one of a brake control or a gear shift control. See e.g. FIGS. 3 and 4. The base may comprise an end cap; the grip assembly may comprise an end cap for the second end; the end cap may comprise a slot. See e.g. FIGS. 7A-7D and 8A-8D.

The grip assembly may be secured by a method comprising the steps of sliding the base onto the handlebar and securing the second end to the handlebar with the retaining arrangement of the accessory. See e.g. FIGS. 5A-5C. The grip assembly may be secured by a method comprising the steps of sliding the base onto the handlebar and securing the first end to the handlebar with the retaining arrangement and securing the second end to the handlebar with the retaining arrangement of the accessory. See e.g. FIGS. 3, 4, 5A-5C, 6A-6B, 7A-7F and 8A-8F.

According to an exemplary embodiment as shown schematically in FIGS. 3-4, 5A-5C, 6A-6B, 7F and 8F, a method of attachment of a grip assembly comprising a base with a first end and a second end comprising a sleeve onto a handlebar of a bicycle also configured for attachment of at least one accessory with a retaining arrangement may comprise the steps of (a) sliding the base onto the handlebar and (b) securing the second end to the handlebar with the retaining arrangement of the accessory; the base may be secured to the handlebar at the second end with the sleeve by the retaining arrangement of the accessory. See e.g. FIGS. 5A-5C and 6A-6B. According to an exemplary embodiment as shown schematically in FIGS. 3-4, 5A-5C, 6A-6B, 7F and 8F, the method of attachment for a grip assembly with the first end comprising a retaining arrangement may comprise the step of securing the first end to the handlebar with the retaining arrangement so that the base may be secured to the handlebar at the first end by the retaining arrangement of the base. As shown schematically in FIGS. 5A-5C, 6A-6B, 7F and 8F, the retaining arrangement for the first end may comprise a collar; the retaining arrangement of the accessory may comprise a clamp. The step of securing the first end may be performed before the step of securing the second end; the step of securing the second end may be performed before the step of securing the first end. See e.g. FIGS. 5A-5C and 6A-6B. The method may comprise the step of fitting the accessory onto the handlebar; the step of fitting the accessory onto the handlebar may comprise sliding the accessory onto the handlebar. The method may comprise the step of providing a grip for the grip assembly. See e.g. FIGS. 5A-5C and 6A-6B. The step of securing the second end of the handlebar may comprise at least partially compressing the sleeve onto the handlebar. See e.g. FIGS. 3, 4, 6A, 7F and 8F. As shown schematically in FIGS. 5A-5C, 6A-6B, 7F and 8F, each retaining arrangement may comprise a retaining mechanism; the retaining mechanism may comprise a clamp.

According to an exemplary embodiment as shown schematically in FIGS. 3-4, 5A-5C and 6A-6B, a grip assembly may be configured to be mounted on a handlebar of a bicycle using a retaining mechanism to be mounted on the handlebar comprising a base configured to be installed onto the handlebar providing a first end and a second end; the base may comprise a sleeve at the second end; the base may comprise an end cap; the sleeve of second end of the base may be configured to be retained to the handlebar by the retaining mechanism. See e.g. FIGS. 5A-5C and 6A-6B. The retaining mechanism may comprise a clamp at the second end; the retaining mechanism may comprise a clamp at the first end; the retaining mechanism may comprise an accessory; the clamp at the second end may comprise an accessory. See e.g. FIGS. 3, 4, 5A-5C, 6A-6B, 7A-7F and 8A-8F.

According to an exemplary embodiment as shown schematically in FIGS. 3-4, 5A-5C and 6A-6B, a grip assembly may be configured to be mounted on a handlebar of a bicycle using a retaining mechanism of an accessory to be mounted on the handlebar. The grip assembly may comprise a base configured to be installed onto the handlebar providing a first end and a second end and a retaining mechanism configured to retain the first end of the base onto the handlebar. See e.g. FIGS. 3, 4, 5A-5C, 6A-6B, 7A-7F and 8A-8F.

As shown schematically in FIGS. 5A-5C, 6A-6B, 7A-7F and 8A-8F, the base may comprise a cutout at the first end and a sleeve at the second end; the sleeve of second end of the base may be configured to be retained to the handlebar by the retaining mechanism of the accessory; the sleeve may comprise a slot arrangement at the second end.

As shown schematically in FIGS. 5A-5C and 6A-6B, the retaining mechanism for the first end of the base may comprise a clamp and/or a collar/ring; the collar may be secured by a fastener; the collar may be configured to be secured onto the handlebar at the cutout at the first end of the base.

As shown schematically in FIGS. 5A-5C, 6A-6B, 7F and 8F, the retaining mechanism for the accessory may comprise a clamp; the clamp may be secured by at least one fastener. The sleeve may be configured to be compressed onto the handlebar by the retaining mechanism for the accessory; the sleeve may comprise features configured to facilitate engagement with the handlebar for secure attachment; the features may comprise grooves; the slot arrangement of the sleeve may comprise a single slot; the slot arrangement of the sleeve may comprise multiple slots (e.g. configured to facilitate installation by sliding and mounting/retention by compression onto the handlebar). See e.g. FIGS. 5A-5C, 7A-7F and 8A-8F.

As shown schematically in FIGS. 5A-5C and 6A-6B, the grip mechanism may comprise a grip for the base; the grip may comprise an overmold (e.g. rubber/rubberized grip, elastomeric material/tube, etc.). The grip assembly may comprise an end cap for the second end. See FIGS. 7A-7D and 8A-8D.

As shown schematically in FIGS. 3-4, 5A-5C and 6A-6B, the accessory may comprise one of a brake control and/or a gear shift control. The grip assembly may be secured by a method comprising the steps of sliding the base onto the handlebar and securing the first end to the handlebar with the retaining arrangement and securing the second end to the handlebar with the retaining arrangement of the accessory. See FIGS. 3-4, 5A-5C and 6A-6B.

According to an exemplary embodiment as shown schematically in FIGS. 3-4, 5A-5C, 6A-6B, 7F and 8F, a method of attachment of a grip assembly comprising a base with a first end with a retaining arrangement and a second end comprising a sleeve onto a handlebar of a bicycle also configured for attachment of at least one accessory with a retaining arrangement may comprise the steps of (a) sliding the base onto the handlebar; (b) securing the first end to the handlebar with the retaining arrangement; (c) securing the second end to the handlebar with the retaining arrangement of the accessory; the base may be secured to the handlebar at the first end by the retaining arrangement of the base and at the second end with the sleeve by the retaining arrangement of the accessory. See e.g. FIGS. 3, 4, 5A-5C, 6A-6B, 7A-7F and 8A-8F.

As shown schematically in FIGS. 3-4, 5A-5C, 6A-6B, 7F and 8F, the method may comprise the step of fitting the accessory onto the handlebar. The step of securing the first end may be performed before the step of securing the second end; the step of securing the second end may be performed before the step of securing the first end. The step of fitting the accessory onto the handlebar may comprise sliding the accessory onto the handlebar; the step of securing the second end of the handlebar may comprise at least partially compressing the sleeve onto the handlebar. See e.g. FIGS. 3-4, 5A-5C, 6A-6B, 7F and 8F. The method may comprise the step of providing a grip for the grip assembly.

As shown schematically in FIGS. 5A-5C, 6A-6B, 7F and 8F, each retaining arrangement may comprise a ring and/or clamp; each retaining arrangement may comprise a retaining mechanism; the retaining mechanism may comprise a clamp.

As shown schematically in FIGS. 3-4, 5A-5C, 6A-6B, 7A-7F and 8A-8F, the grip assembly is configured to be securely attached by clamping/compression onto each end of a handlebar for the bicycle provided as a tube/tubular form (e.g. with a varying size/diameter, for example in a standard size or reduced size for smaller/youthful/children riders to accommodate smaller hands). As shown schematically in FIGS. 3-4, 5A-5C, 6A-6B, 7F and 8F, the base of the grip assembly is secured by a retaining mechanism at each end; the retaining mechanism at one end is provided by a retaining mechanism with the grip assembly (shown as a collar/clamp/fastener); the retaining mechanism at another end is provided by an accessory (shown as a clamp/fastener arrangement).

As shown schematically in FIGS. 3 and 4, a grip assembly 100 may be secured at one end of a handlebar with a retaining mechanism/assembly AC of one type of accessory (e.g. brake control BR and/or shift control SC). and a grip assembly 100 may be secured at another end of a handlebar with a retaining mechanism/assembly AC of another type (or same type) of accessory (e.g. brake control BR and/or shift control SC). See also FIG. 1.

It is important to note that the present inventions (e.g. inventive concepts, etc.) have been described in the specification and/or illustrated in the FIGURES of the present patent document according to exemplary embodiments; the embodiments of the present inventions are presented by way of example only and are not intended as a limitation on the scope of the present inventions. The construction and/or arrangement of the elements of the inventive concepts embodied in the present inventions as described in the specification and/or illustrated in the FIGURES is illustrative only. Although exemplary embodiments of the present inventions have been described in detail in the present patent document, a person of ordinary skill in the art will readily appreciate that equivalents, modifications, variations, etc. of the subject matter of the exemplary embodiments and alternative embodiments are possible and contemplated as being within the scope of the present inventions; all such subject matter (e.g. modifications, variations, embodiments, combinations, equivalents, etc.) is intended to be included within the scope of the present inventions. It should also be noted that various/other modifications, variations, substitutions, equivalents, changes, omissions, etc. may be made in the configuration and/or arrangement of the exemplary embodiments (e.g. in concept, design, structure, apparatus, form, assembly, construction, means, function, system, process/method, steps, sequence of process/method steps, operation, operating conditions, performance, materials, composition, combination, etc.) without departing from the scope of the present inventions; all such subject matter (e.g. modifications, variations, embodiments, combinations, equivalents, etc.) is intended to be included within the scope of the present inventions. The scope of the present inventions is not intended to be limited to the subject matter (e.g. details, structure, functions, materials, acts, steps, sequence, system, result, etc.) described in the specification and/or illustrated in the FIGURES of the present patent document. It is contemplated that the claims of the present patent document will be construed properly to cover the complete scope of the subject matter of the present inventions (e.g. including any and all such modifications, variations, embodiments, combinations, equivalents, etc.); it is to be understood that the terminology used in the present patent document is for the purpose of providing a description of the subject matter of the exemplary embodiments rather than as a limitation on the scope of the present inventions.

It is also important to note that according to exemplary embodiments the present inventions may comprise conventional technology (e.g. as implemented and/or integrated in exemplary embodiments, modifications, variations, combinations, equivalents, etc.) or may comprise any other applicable technology (present and/or future) with suitability and/or capability to perform the functions and processes/operations described in the specification and/or illustrated in the FIGURES. All such technology (e.g. as implemented in embodiments, modifications, variations, combinations, equivalents, etc.) is considered to be within the scope of the present inventions of the present patent document.

The invention claimed is:

1. A grip assembly configured to be mounted on a handlebar of a bicycle using a retaining mechanism of an accessory to be mounted on the handlebar comprising:
a base configured to be installed onto the handlebar providing a first end and a second end;
wherein the base comprises a sleeve at the second end;
wherein the sleeve of second end of the base is configured to be retained to the handlebar by the retaining mechanism of the accessory.

2. The grip assembly of claim 1 wherein a retaining mechanism is configured to retain the first end of the base onto the handlebar.

3. The grip assembly of claim 2 wherein the retaining mechanism for the first end of the base comprises a clamp.

4. The grip assembly of claim 2 wherein the retaining mechanism for the first end of the base comprises a collar; wherein the collar is secured by a fastener.

5. The grip assembly of claim 1 wherein the retaining mechanism for the accessory comprises a clamp; wherein the clamp is secured by at least one fastener.

6. The grip assembly of claim 1 wherein the sleeve is configured to be compressed onto the handlebar by the retaining mechanism for the accessory.

7. The grip assembly of claim 1 further comprising a grip for the base; wherein the grip comprises an overmold.

8. The grip assembly of claim 1 wherein the accessory comprises one of a brake control or a gear shift control.

9. A method of attachment of a grip assembly comprising a base with a first end and a second end comprising a sleeve onto a handlebar of a bicycle also configured for attachment of at least one accessory with a retaining arrangement comprising the steps of:
(a) sliding the base onto the handlebar;
(b) securing the second end to the handlebar with the retaining arrangement of the accessory;
so that the base is secured to the handlebar at the second end with the sleeve by the retaining arrangement of the accessory.

10. The method of claim 9 wherein the first end of the grip assembly comprises a retaining arrangement and further comprising the step of securing the first end to the handlebar with the retaining arrangement so that the base is secured to the handlebar at the first end by the retaining arrangement of the base; wherein the retaining arrangement for the first end comprises a collar.

11. The method of claim 10 wherein the retaining arrangement of the accessory comprises a clamp.

12. The method of claim 10 wherein each retaining arrangement comprises a retaining mechanism.

13. The method of claim 10 wherein the retaining mechanism comprises a clamp.

14. A grip assembly configured to be mounted on a handlebar of a bicycle using a retaining mechanism of an accessory to be mounted on the handlebar comprising:
(a) a base configured to be installed onto the handlebar providing a first end and a second end;
(b) a retaining mechanism configured to retain the first end of the base onto the handlebar;
wherein the base comprises a cutout at the first end;
wherein the base comprises a sleeve at the second end;
wherein the sleeve of second end of the base is configured to be retained to the handlebar by the retaining mechanism of the accessory.

15. The grip assembly of claim 14 wherein the retaining mechanism for the first end of the base comprises a clamp.

16. The grip assembly of claim 14 wherein the retaining mechanism for the first end of the base comprises a collar; wherein the collar is secured by a fastener.

17. The grip assembly of claim 14 wherein the retaining mechanism for the accessory comprises a clamp; wherein the clamp is secured by at least one fastener.

18. The grip assembly of claim 14 wherein the sleeve is configured to be compressed onto the handlebar by the retaining mechanism for the accessory.

19. The grip assembly of claim 14 further comprising a grip for the base; wherein the grip comprises an overmold.

20. The grip assembly of claim 14 wherein the accessory comprises one of a brake control or a gear shift control.
